(19) United States
(12) Patent Application Publication
(10) Pub. No.: US 2006/0189216 A1
(43) Pub. Date: Aug. 24, 2006

(54) Camera module connector keying structure

(76) Inventor: Ming-Hsun Yang, Taipei (TW)

Correspondence Address: MOLEX INCORPORATED, 2222 WELLINGTON COURT, LISLE, IL, 60532, US

(21) Appl. No.: 11/356,942

(22) Filed: Feb. 17, 2006

(30) Foreign Application Priority Data
Feb. 18, 2005 (TW) 94262705

(51) Int. Cl. H01R 13/64

(52) U.S. Cl. 439/680

(57) ABSTRACT

A camera module connector with an anti-disorientation structure includes an electrical connector and a camera module. The electrical connector has an housing, a plurality of signal terminals and a shield. The housing forms a receiving space. The signal terminals are fixed in the housing. The shield covers the housing. The camera module is positioned in the receiving space of the housing. The signal terminals have one end for contacting contact pads on four sides of the substrate of the camera module, so the camera module is electrically connected to the electrical connector. The housing of the electrical connector forms a notch, and the main body of the camera module forms a corresponding protrusion. The protrusion cooperates with the notch to form a keying structure with an orientating function when the camera module is positioned in the receiving space of the connector.

### BACKGROUND OF THE INVENTION

The present invention relates to a camera module connector with an anti-disorientation structure, and more particularly, to a camera module connector having an electrical connector for receiving a camera module therein to make the camera module electrically connect with a circuit board.

Because of the development of wireless communication and the rapid revolution in high technology, portable electronic products, such as mobile phones, PDAs and Tablet PCs, are assembled with different electronic additional-modules such as a camera module for taking pictures, for satisfying the requirements of consumers.

Reference is made to FIGS. 1 and 2 which illustrate a conventional camera module connector including an electrical connector 6 and a camera module 7. The electrical connector 6 is mounted on a circuit board 8 for accommodating the camera module 7.

The electrical connector 6 includes an insulative housing 61, a plurality of signal terminals 62 and a metallic housing 63 in the form of a shield. The housing 61 forms a receiving space 611 therein. The signal terminals 62 are fixed respectively on four side walls 612 of the housing 61. The shield 63 sheathes and wraps the housing 61.

One end of the signal terminals 62 are soldered with contact pads 81 of the circuit board 8 correspondingly, so that the electrical connector 6 is electrically connected to the circuit board 8. The camera module 7 is positioned in the receiving space 611 of the housing 61 of the connector 6. The other ends of the signal terminals 62 abut against contact pads 711 on a printed circuit substrate 71 of the camera module 7, so that the camera module 7 is electrically connected to the connector 6. Therefore, the camera module 7 can electrically connect to the circuit board 8 through the connector 6.

However, the conventional camera module connector, whose respective electrical characteristics relate to the signal terminals 62 of the connector 6 and the contact pads 711 of the camera module 7, are not uniform in their opposition to each other. Therefore, the camera module 7 must be orientated accurately to the receiving space 611 of the electrical connector 6 during assembling. If the camera module 7 is positioned in the wrong direction, it can't work normally and can even be damaged.

With the above-described problems in prior art in view, an object of the present invention is to provide a camera module connector that improves upon the aforesaid disadvantages of the conventional camera module connector.

### SUMMARY OF THE INVENTION

An object of the present invention is to provide a camera module connector with an anti-disorientation structure, which provides an orientating function to the camera module when it is positioned into the connector, so that the camera module can be prevented from being assembled in the wrong direction.

In order to achieve the above objects, the present invention provides a camera module connector with a keying structure, which includes an electrical connector and a camera module. The connector includes an housing, a plurality of signal terminals and a metallic housing. The housing has a bottom wall, four side walls and a receiving space formed between the bottom wall and the four side walls. Each of the side walls of the housing are formed with a cutout and a plurality of terminal grooves for respectively receiving the signal terminals therein. One end of each of the signal terminals extends into the receiving space, and the other end of the signal terminals extends outside of the housing. The shield covers the housing. The camera module includes a main body and a substrate. The substrate has a top surface connected with a bottom of the main body. The substrate has a plurality of contact pads disposed at four sides thereof, respectively. The main body of the camera module is protruded with a protrusion corresponding to the cutout. The camera module is positioned in the receiving space of the electrical connector. One end of the signal terminals contact the contact pads of the camera module, respectively. The protrusion and the cutout match each other, thereby forming a keying structure

The present invention uses the housing of the electrical connector formed with the cutout and the main body of the camera module formed with the corresponding protrusion, so that the protrusion can cooperate with the cutout to form the anti-disorientation structure with an orientating function when the camera module is positioned in the receiving space of the electrical connector. The orientating function is employed when the camera module is being positioned in the receiving space, thereby the camera module is prevented from being positioned in the wrong direction. Because the camera module cannot be positioned incorrectly, a user will always be able to use the camera module effectively and will not have to worry about damaged being caused to the camera module.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is an exploded perspective view of a known camera module connector;

FIG. 2 is an exploded perspective view of a camera module connector constructed in accordance with the principles of the present invention;

FIG. 3 is a perspective view of the camera module connector of FIG. 2;

FIG. 4 is a top plan view of the camera module of FIG. 2;

FIG. 5 is a cross-sectional view of the connector of FIG. 4, taken along line 5-5 thereof;

FIG. 6 is a cross-sectional view of the connector of FIG. 4 along line 6-6 thereof;

FIG. 7 is an exploded perspective view of a connector according to the present invention, with one of the terminals slightly removed for clarity; and,

FIG. 8 is an exploded perspective view of another embodiment of a connector according to the present invention.

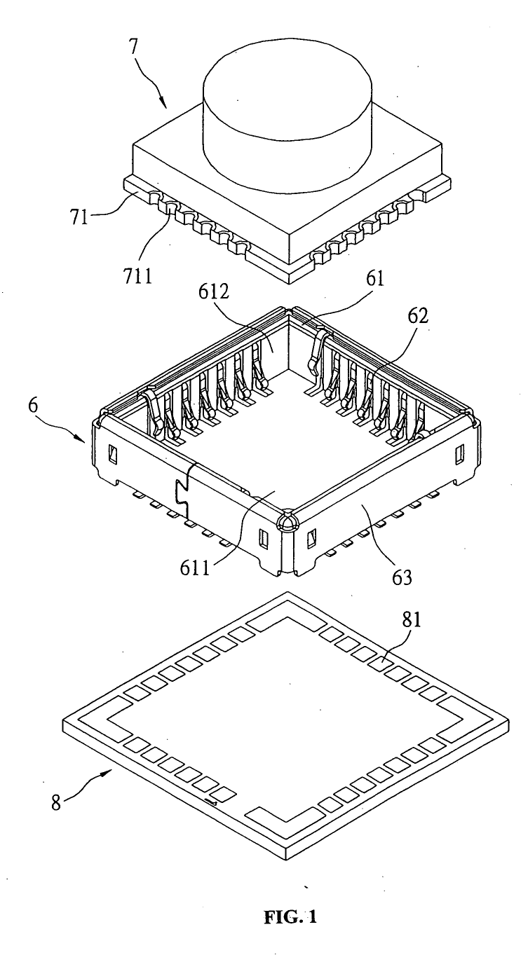

### DETAILED DESCRIPTION OF THE PREFERRED EMBODIMENTS

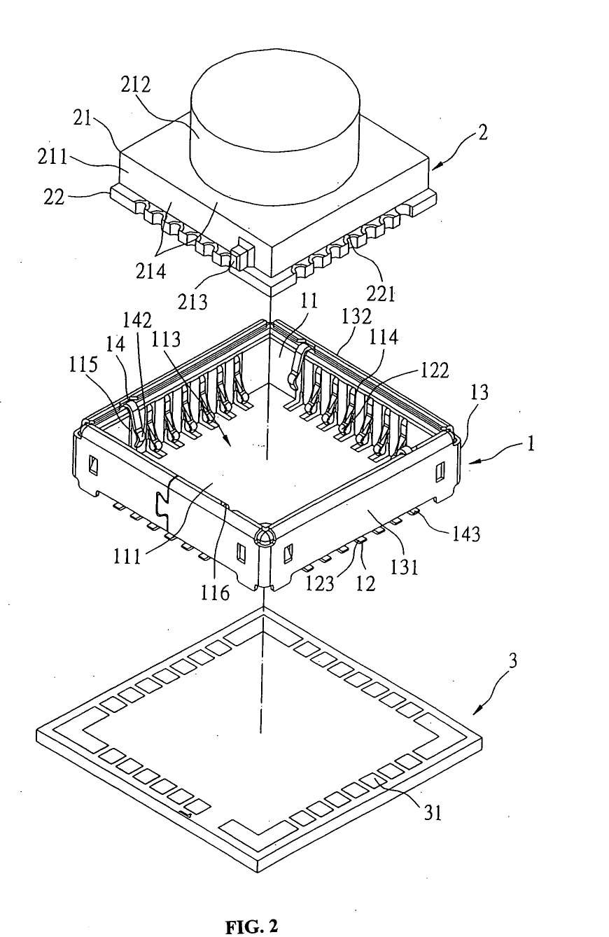

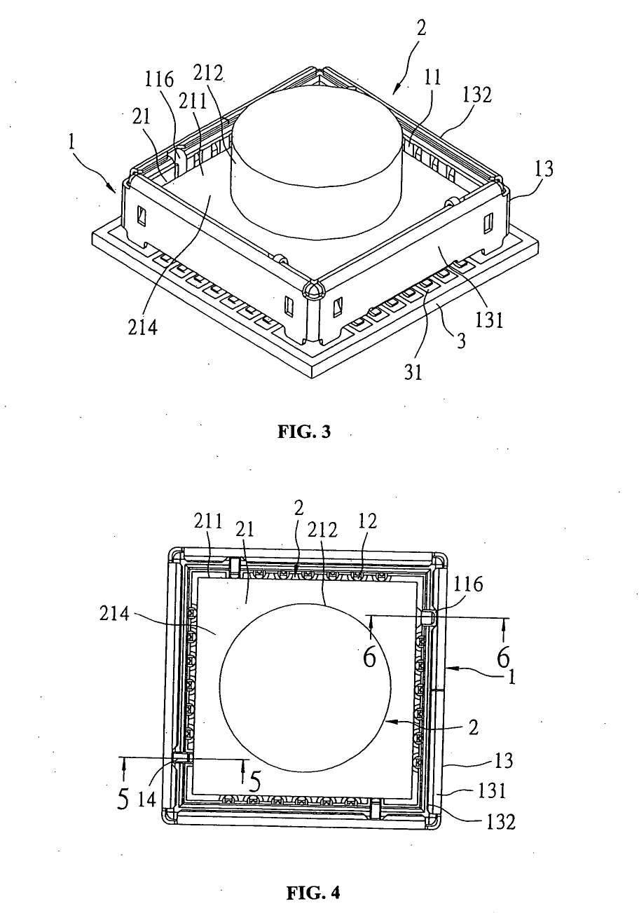

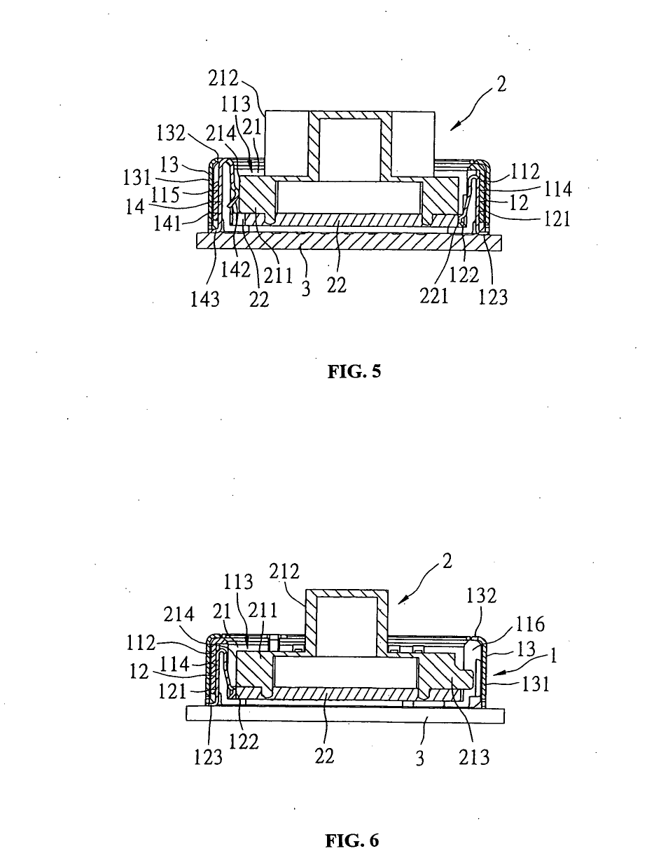

FIGS. 2 and 6 illustrate a camera module connector with an anti-disorientation structure, which includes a connector 1 and a camera module 2. The connector 1 is assembled on a circuit board 3 for receiving the camera module 2 therein.

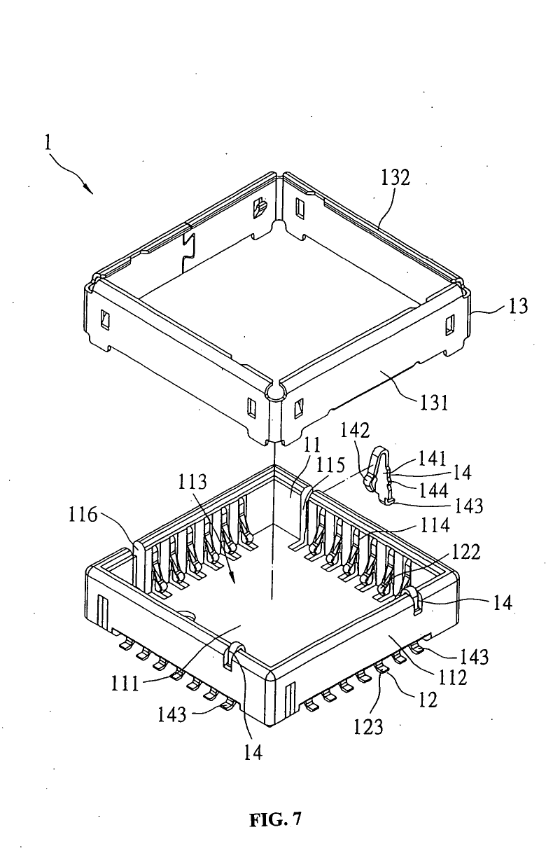

The connector 1 includes an housing 11, a plurality of signal terminals 12, a shield 13 and at least one grounding pin 14. The housing 11 is made of plastic material, which has a bottom wall 111 and four side walls 112 formed integrally (as shown in FIG. 7). A receiving space 113 is formed between the bottom wall 111 and the four side walls 112. The four side walls 112 of the housing 11 are formed with a plurality of terminal grooves 114, respectively. The terminal grooves 114 penetrate through a connecting portion between the side walls 112 and the bottom wall 111. The terminal grooves 114 also extend upwardly to an inner edge of side walls 112. The side walls 112 of the housing 11 also form at least one grounding-pin groove 115. In this embodiment, the side walls 112 form three grounding-pin grooves 115 therein. The side walls 112 of the housing 11 are further formed with a cutout 116.

The signal terminals 12 are made of electrically conductive and elastic metal material. Each of the signal terminals 12 includes a main portion 121 with two ends, a contact portion 122 extending from one end of the main portion 121 and a solder tail portion 123 extending from anther end of the main portion 121. The main portion 121 of the signal terminals 12 are fixed in the terminal grooves 114 on the four side walls 112 of the housing 11, so that the signal terminals 12 are mounted on the housing 11. Each contacting portion 122 of the signal terminals 12 extends elastically into the receiving space 113. Each of the solder tail portions 123 of the signal terminals 12 is exposed outside the bottom surface of the housing 11. The solder tail portions 123 of the signal terminals 12 can be soldered to contact pads 31 on the circuit board 3 correspondingly, so that the connector 1 is electrically connected to the circuit board 3.

The grounding pins 14 are made of electrically conductive and elastic metal material. Each of the grounding pins 14 has a main portion 141 with two ends, a contact portion 142 extending from one end of the main portion 141 and a solder tail portion 143 extending from the other end of the main portion 141. The main portions 141 of the grounding pins 14 are also fixedly in the grounding-pin grooves 115 of the housing 11, and the main portion 141 forms interfering portions 144 at two sides thereof. The interfering portions 144 are interfered with inner sides of the grounding-pin grooves 115, so that the grounding pins 14 can be fixed in the housing 11. The grounding pins 14 are mounted in the housing 11. The grounding pins 14 are located at four sides of the receiving space 113, respectively. The contact portions 142 of the grounding pins 14 extend respectively beyond the side walls 112 of the housing 11, and also extend elastically into the receiving space 113. The solder tail portions 143 of the grounding pins 14 are exposed outside the bottom surface of the housing 1, which are used to solder with the corresponding contact pads 31 of the circuit board 3. Therefore, the connector 1 is also grounded to the circuit board 3.

The shield 13 has four side plates 131 connecting with each other. The side plates 131 have a verge portion 132 extended inwardly from an upper edge thereof. The shield 13 sheathes downwardly and is fixedly to the housing 11. The verge portions 132, formed at the upper edge of the shield 13, presses against the top surface of the housing 11. This causes the housing 11 to be surrounded by the shield 13. Then, the soldering portions 123 of the signal terminals 12 and the soldering portions 143 of the grounding pins 14 are soldered with the contact pads 31 of the circuit board 3 correspondingly, so that the connector 1 is electrically connecting with and is grounded to the circuit board 3.

The camera module 2 includes a main body 21 and a substrate 22. The main body 21 has a module base 211 that is square-post shaped and a lens portion 212 that is cylinder-shaped. The lens portion 212 connects to a top surface of the module base 211. The module base 211 forms a protrusion 213 corresponding to the cutout 116. The camera module 2 is coated with a metal layer 214 on a top surface and four sides of the module base 211 of the main body 21 at least. The metal layer 214 is made of metallic material, so that it prevents EMI (electromagnetic interference). The periphery of the lens portion 212 of the main body 21 can be coated with the metal layer or not. The substrate 22 has a top surface connecting to a bottom surface of the module base 211 of the main body 21. The substrate 22 has a plurality of contact pads 221 disposed at four sides thereof. The contact pads 221 are concaved separately at four sides of the substrate 22.

The camera module 2 is positioned in the receiving space 113 of the housing 11 of the electrical connector 1, so that the contact portions 122 of the signal terminals 12, which are fixed in the side walls 112 of the housing 11, abut against the contact pads 221 disposed on four sides of the substrate 22 of the camera module 2 along a lateral direction, respectively. Therefore, the camera module 2 is electrically connected to the connector 1, and the camera module 2 can electrically connect to the circuit board 3 via the connector 1.

When the camera module 2 is positioned in the receiving space 113 of the housing 11 of the electrical connector 1, the protrusion 213, formed on the module base 211 of the main body 21 of the camera module 2, matches with the cutout 116 formed on the side wall 112 of the housing 11. A keying structure is therefore achieved therefore for preventing erroneous insertion of the camera module into the receiving space of the housing 11. The camera module 2 is positioned in the receiving space 113 with an orientation characteristic, so that it prevents the camera module 2 from being positioned in the wrong direction.

In addition, after the camera module 2 is positioned in the receiving space 113 of the housing 11 of the electrical connector 1, the contact portions 142 of the grounding pins 14 abut against the metal layer 214 formed on the periphery of the module base 211 of the main body 21 of the camera module 2. The camera module 2 and the electrical connector 1 are therefore grounded. The camera module connector with a keying structure is thereby accomplished by the above-mentioned structure.

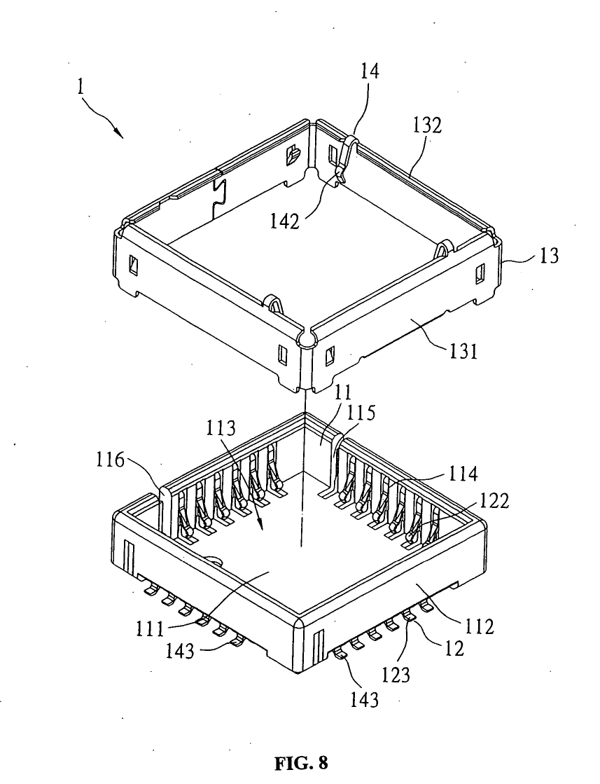

Furthermore, reference is made in FIG. 8, in this embodiment, the grounding pin 14 and the shield 13 are formed in integrally one piece. In other words, the grounding pins 14 are extended downwardly from an upper edge of side plates 131 of the shield 13, respectively. Each of the grounding pins 14 has a contacting portion 142 that is extended elastically into the receiving space 113 of housing 11.

The present invention uses the housing 11 of the electrical connector 1 formed with the cutout 116 and the main body 21 of the camera module 2 formed with the corresponding protrusion 213, so that the protrusion 213 can cooperate with the cutout 116 to form the anti-disorientation structure with an orientating function when the camera module 2 is positioned into the receiving space 113 of the housing 11 of the electrical connector 1. If the camera module 2 is positioned in the wrong direction, the protrusion 213 is interfered by the connector 1 and the camera module 2 can't be assembled into the receiving space 113. The orientating function is employed when the camera module 2 is being positioned in the receiving space 113, thereby the camera module 2 is prevented from being positioned in the wrong direction. Because the camera module 2 cannot be positioned incorrectly a user will always be able to use the camera module 2 effectively and won't have to worry about damaged being caused to the camera module 2.

While the preferred embodiment of the invention have been shown and described, it will be apparent to those skilled in the art that changes and modifications may be made therein without departing from the spirit of the invention, the scope of which is defined by the appended claims.

What is claimed is:

1. A camera module connector assembly with a keying feature, comprising:
an electrical connector, including an insulative housing, a plurality of signal terminals and a shield, said housing having a bottom wall, four side walls and a receiving space formed between said bottom wall and said four side walls, said housing side walls including at least notch and a plurality of terminal-receiving grooves, each of the terminal-receiving grooves respectively receiving a single signal terminal therein, one end of each of said signal terminals extending into said receiving space, the other end of each of said signal terminals extending outside said housing, the shield covering said housing; and,
a camera module, including a main body and a substrate, said substrate having a top surface connected with a bottom of said main body, said substrate having a plurality of contact pads disposed at four sides thereof, respectively, said main body of said camera module including a protrusion in alignment with said notch; and,
wherein, when said camera module is positioned in said receiving space of said electrical connector, one end of said signal terminals contacts with said contact pads of said camera module, respectively, said protrusion is received within said notch and said camera module is properly oriented in said connector.

2. The camera module connector assembly of claim 1, wherein said connector further includes a grounding pin, the grounding pin being located along one edge of said receiving space, one end of said grounding pin extending into said receiving space to and contacts a periphery of said camera module.

3. The camera module connector assembly of claim 2, wherein said housing side walls include at least one grounding-pin groove, said grounding pin having a main portion with two ends, a contact portion extending from one end of the main portion and a solder tail portion extending from another end of said main portion, said main portion of said grounding pin is being held said housing grounding-pin groove, said grounding pin contact portion extending into said receiving space, and said grounding pin solder tail portion extending outside of said housing.

4. The camera module connector assembly of claim 1, wherein said main body of said camera module includes a module base and a lens portion, the lens portion being connected with a top surface of said module base, said substrate has a top surface connected to a bottom surface of said module base of said main body, said protrusion is formed on said module base of said main body of said camera module.
